(19) United States
(12) Patent Application Publication
(10) Pub. No.: US 2005/0212981 A1
(43) Pub. Date: Sep. 29, 2005

(54) Dual use front or rear projection television set that folds campactly for transport and storage

(76) Inventors: Johnson Lin, Plano, TX (US); Tsen-Hwang Lin, Dallas, TX (US)

Correspondence Address: WILLIAM A. FIETZ, 5608 SANDALWOOD DRIVE, MCKINNEY, TX, 75070, US

(21) Appl. No.: 10/812,251

(22) Filed: Mar. 29, 2004

(51) Int. Cl. H04N 5/64

(52) U.S. Cl. 348/788

(57) ABSTRACT

A modular system for projection television is disclosed wherein the major components may be removed from the frame or cabinet, which may then be folded into a compact unit for transporting. The projector is of a type that may be used either as a front or rear projecting television. Where appropriate, amplifiers, speakers, projector and optical devices are electrically connected within the enclosure, which may be achieved through the use of slot connectors or other means that permit easy withdrawal and reinsertion of the modules. The screen may be detached and used in the front projection mode, or designed to fold along with the frame or cabinet.

### CROSS REFERENCE TO RELATED APPLICATIONS

Not Applicable

### FEDERALLY SPONSORED RESEARCH OR DEVELOPMENT

Not Applicable

### REFERENCE TO A MICROFICHE APPENDIX

Not Applicable

### BACKGROUND OF THE INVENTION

The invention relates to television sets, particularly sets wherein the image is projected either to a separate screen located outside the set, or to a self-contained screen. In the former case known as front projection (FP), the image is formed on a display panel and light is passed through the image and onto a separate screen. In the second type of projection TV, known as rear projection (RP), the light is reflected off the image display panel and onto a screen, usually located within the set itself.

Projection TV has become increasingly popular as viewers demand larger and larger screens for home viewing, or for presentation to an assemblage of a number of participants in a classroom or at a conference for example. Other methods of achieving a larger picture, cathode ray tubes or plasma screens, become heavy, cumbersome and/or expensive above a screen size of about 40 inches. Thus, projection TV, offering a reasonably priced alternative, is the leading technology for large screen viewing at the present time.

FP display can conveniently serve the purpose of group presentation or video media in a conference room or a room at home with a large gathering by connecting the projector to a signal source. However, because of the need for an unobstructed path between projector and screen, the dangers inherent in the wiring often loosely stretched across the room, and the inconvenience of setting up the bulky screen, the FP alone is losing favor. In recent years the self-contained RP has gained an edge over the FP and is probably the most likely candidate to replace the cathode ray tube in home television.

The present invention is a modular system that can serve either as FP or RP. Such dual purpose capacity might be especially valuable at a meeting or conference where different size groups are meeting at different times in different rooms. Furthermore, the system can be disassembled into its component parts and easily transported, since the cabinet and screen assembly fold into a compact unit, and the other components can be carried separately.

### BRIEF SUMMARY OF THE INVENTION

This disclosure is for a projection television system comprising a frame or cabinet that can be folded into a compact unit, and other detachable components such as the projector, the optical devices, audio components and a viewing screen. The frame or cabinet when unfolded accommodates the other components in the appropriate locations for rear projection television viewing. Electrical connectivity of the assemblage is achieved by the use of slot connectors or other means that provide for quick and effective insertion of each unit into the frame or cabinet. Non electrical components, such as optical mirrors or devices, are designed so they can be removed for transport of the system, is thereby reducing weight and fragility. Finally, the projector may be used as a stand alone or in conjunction with some of the other components such as speakers for front projection to a separate screen or the screen detached from the unit and set up externally.

### BRIEF DESCRIPTION OF THE DRAWINGS

FIG. 1 is a perspective drawing of the foldable front projection/ rear projection (FP/RP) television set.

FIG. 2 is a view of the system in a FP mode using the projector, speakers, and screen removed from the set.

FIG. 3 is an exploded view of one embodiment of the system.

FIG. 4 is a phantom view of the system used in an RP mode.

FIG. 5 is a cross sectional side view of the system as used in a RP mode with one mirror.

FIG. 6 is a cross sectional side view of the foldable television set with a second mirror to increase optical path length.

FIG. 7 is a rear view of the foldable television set showing a pleated section of the rear wall.

FIG. 8 shows more detail of the folding process.

FIG. 9 shows an embodiment with a rigid back, and the system partly folded.

FIG. 10 is a cross sectional side view of an embodiment using a folding method wherein the back comprises rigid members which slide inside one another as the folding proceeds.

FIG. 11 shows detail of rigid folding sides in another embodiment of the system. Other aspects of this embodiment are similar to the other embodiments.

### DETAILED DESCRIPTION OF THE INVENTION

In this invention we use various folding mechanisms to implement a number of concepts for reducing the volume of a TV during transport. Several different embodiments are described here with variations on each of the embodiments.

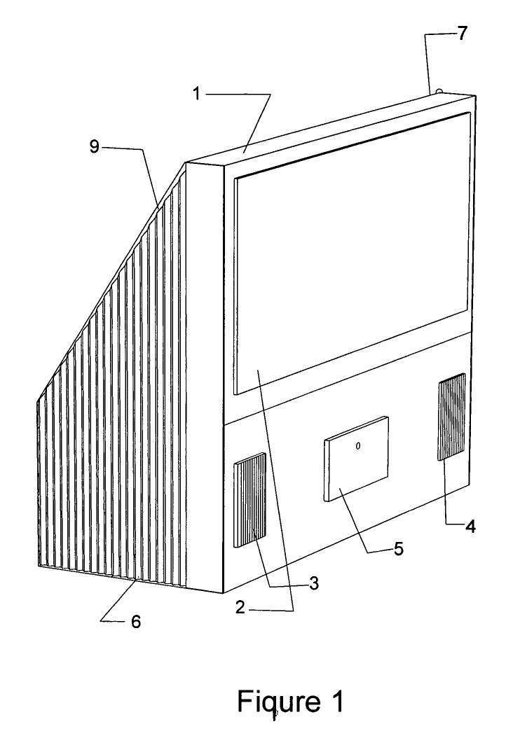

FIG. 1 is a perspective view of one embodiment of the system as used in the rear projection (RP) mode. In this embodiment a main cabinet 1, supports the viewing screen 2, two speakers 3, and 4 near the lower front comers, and a door 5, in the center of the front face of the cabinet to provide access to the interior of the cabinet for removal and/or adjustment of the projector and internal optical and electronic components. All these items may be detachable for use in a front projection (FP) mode. The sides 6, and 7, of the enclosure are pleated and attached to the sloping part of the rear section 9 by means of sliding fasteners in a groove at the sides of the sloping rear section . As the sloping section folds downward the pleats compress and slide forward in the grooves until the rear sloping section reaches a limit somewhat before the vertical position. This limit is the point where the pleated sections are fully compressed and the sliding fasteners in the upper groove are touching one another.

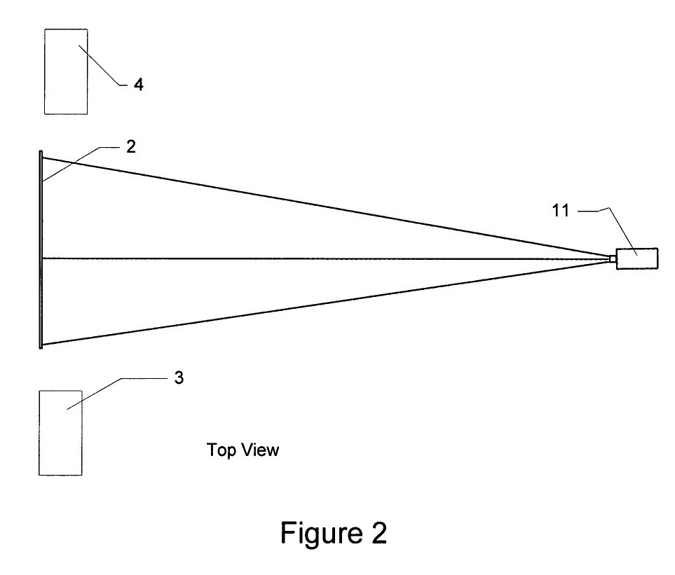

FIG. 2 shows an arrangement where the projector and speakers have been removed from the system and used as a conventional front projection (FP) system. The screen in this embodiment has been removed from the set and used in a standard arrangement, for example at the front of a meeting room. Using the screen from the RP set has the further advantage that it can also be illuminated from the rear as in the RP mode. When used in the FP mode, the speakers may be easily removed by simply pulling forward which disengages the electrical connectors, for example a standard type of slot connector, within the enclosure. Thus the speakers are available for use with the system in the FP mode using separate extension cables that mate with the connectors on the speakers and the projector.

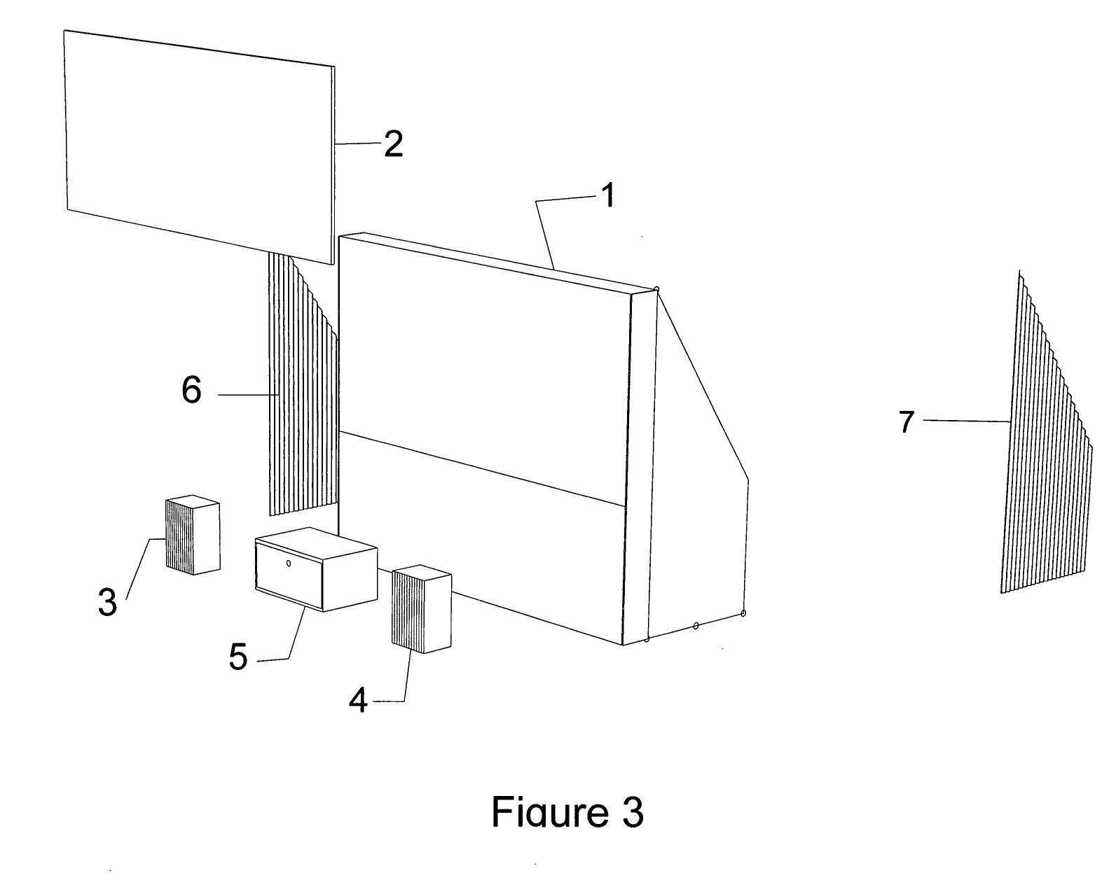

FIG. 3 is an exploded view of the above embodiment of the system showing the pleated side sections, the viewing screen, the speakers, the projector and the projector holder disengaged from the system.

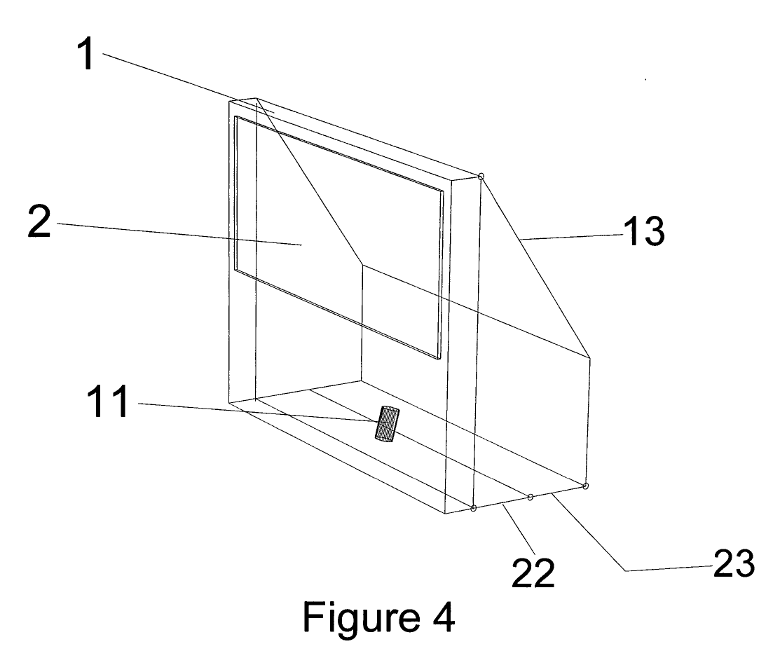

In FIG. 4 the projector and screen have been replaced back into the set for RP operation. Optical paths identical to those in the FP mode may be maintained within the cabinet, resulting in the same quality picture in either mode. FIG. 4 further identifies the folding floor or bottom sections of the cabinet, 22 and 23 hinged to permit folding of the set.

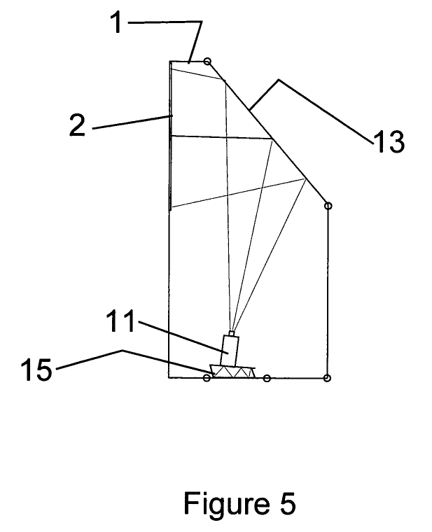

FIG. 5 is a cross sectional side view of an embodiment of the system arranged for television viewing in the RP mode. Internal to the cabinet are the components that make up the optical, electronic, and possibly, other parts of the system. The main projector 11, is removable from the front of the cabinet. It mounts on a fixed carrier 15, that locks into position and holds the projector rigidly in place In the configuration shown in FIG. 5.

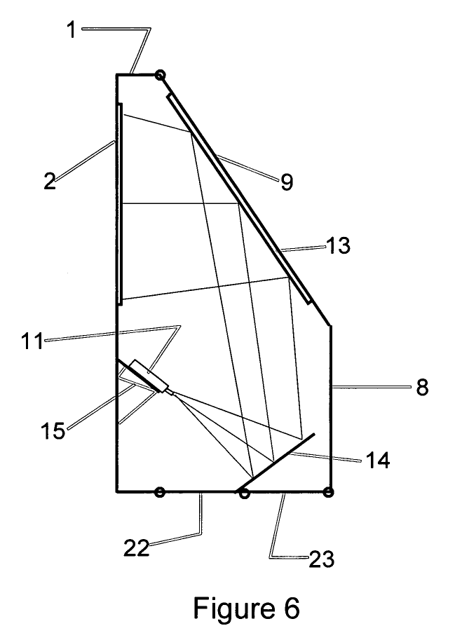

The television beam is reflected by a single mirror 13, to the rear side of the viewing screen 2. In another arrangement, a second mirror may be added and the projector operated facing downward to increase the optical path length and further reduce the system bulk. Such an arrangement is shown in FIG. 6.

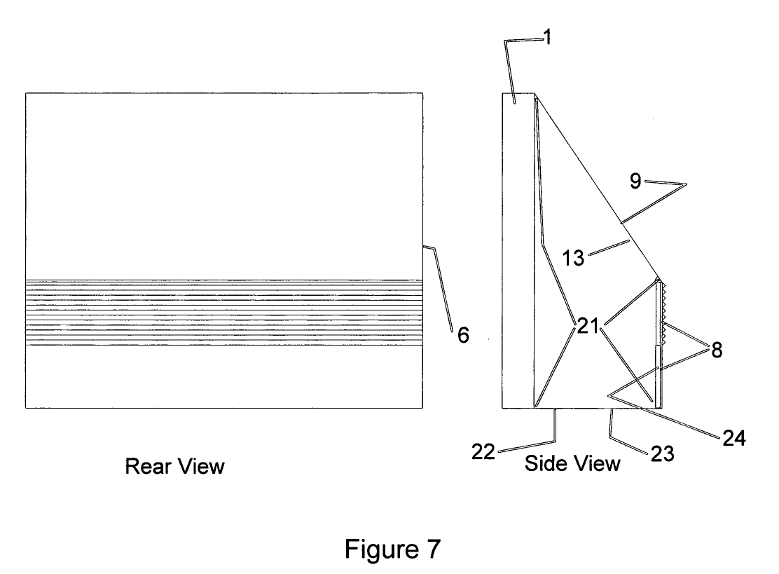

In the embodiment shown in FIG. 6, the cabinet or frame comprises seven sections, a main cabinet 1, two flexible side sections 6, and 7 (not visible in the cross section), a vertical rear section 8, a sloping rear section 9, and two bottom or floor sections, 22 and 23. The rigid main cabinet 1, makes up the front face and serves as the carrier, a sort of box for the rest of the system as the system is folded into a compact unit within and/or against the main cabinet 1. The two sides, 6 and 7, are bellows-like structures in this embodiment that compress with the folding down of sloping rear section 9, to which they are slideably connected at the top. The rear vertical section 8, is made up of a lower rigid part and an upper bellows part as shown in the rear view, FIG. 7. The rear sloping section 9, supports mirror 13, on its inside and is itself a rigid structure. This rear sloping section is attached to a set of telescoping tubes 24, one on the inside of each rear corner of the section to maintain the alignment and rigidity of the system during the folding operation. The bottom section or floor is made up of two pieces 22, and 23 that are hinged to each other and to the front and rear sections of the system as was shown in FIG. 4.

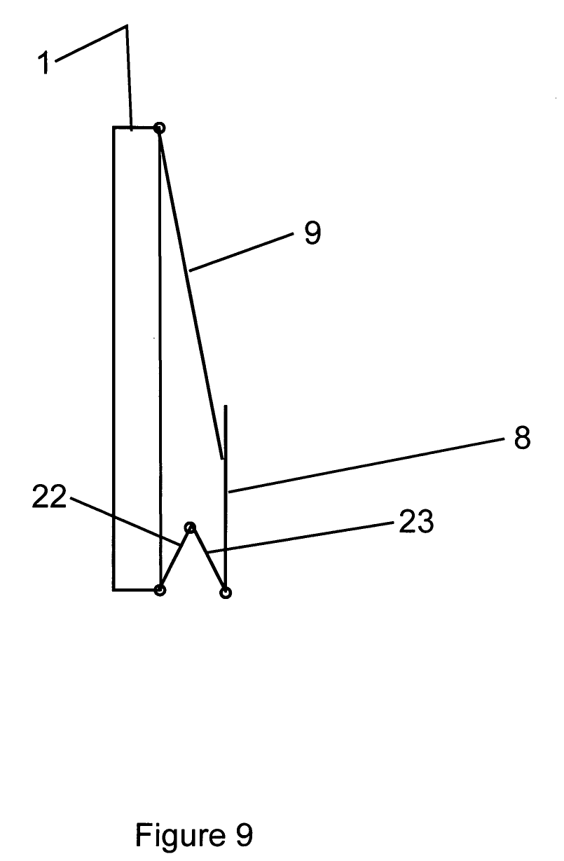

The system is folded by first releasing all the latching fasteners 21 of FIG. 7, (after removing the projector and any other detachable items) then lifting upward at the hinged joint joining rigid bottom sections 22 and 23 while pressing downward on the rear sloping section 9. As the folding proceeds, the telescoping tubes 23 guide the rear sloping section 9 until it reaches the rigid lower part of rear section 8 At this point the folding process is complete and the cabinet is in the fully compacted position shown in FIG. 9.

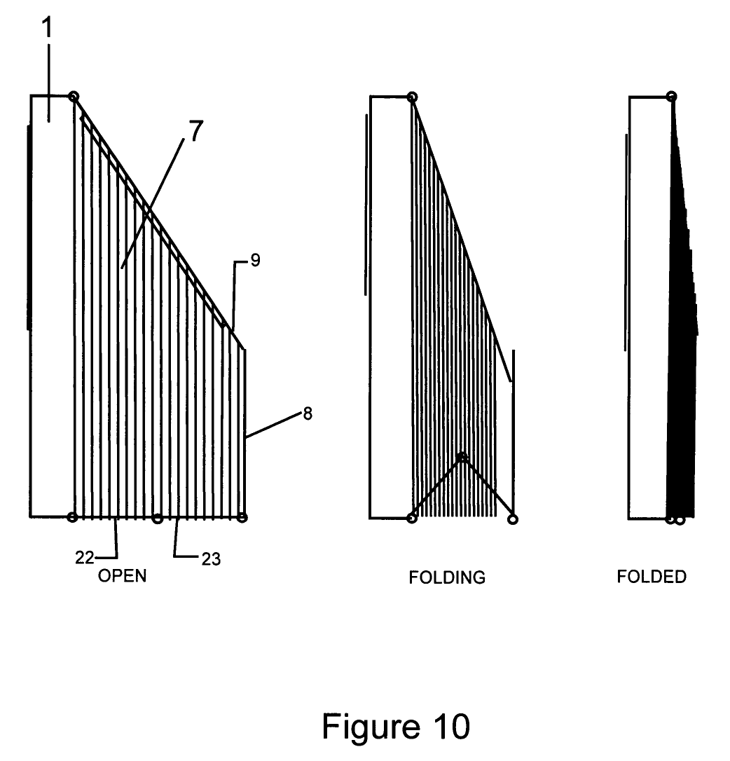

FIG. 10 shows another embodiment of the system as used in RP mode. This embodiment comprises a multi-piece cabinet made up of seven sections to house the components. Section 1 is the base cabinet to which the other components attach directly or indirectly. Sections 6 and 7 make up the sides of the system cabinet pleated as in the previous embodiment. The vertical rear section 8, instead of the being partly pleated, it is one regid section, Folding proceeds in a way similar to the previous embodiment but sloping rear section 9, slides downward inside and contacting the rigid rear section 8 on either side by means of slideable attachments in a groove in rear section 8. Rigid vertical rear section 8 is attached hingeably to bottom sections 22 and 23. Sloping rear section 9 completes the closure of the structure, being hingably attached to the base cabinet 1 at the top of the system, and slideably attached to the vertical rear section 8. Bottom sections 22 and 23, are hingeably attached to each other and to the base cabinet 1, at the front of the set, as well as to the rear vertical section 8

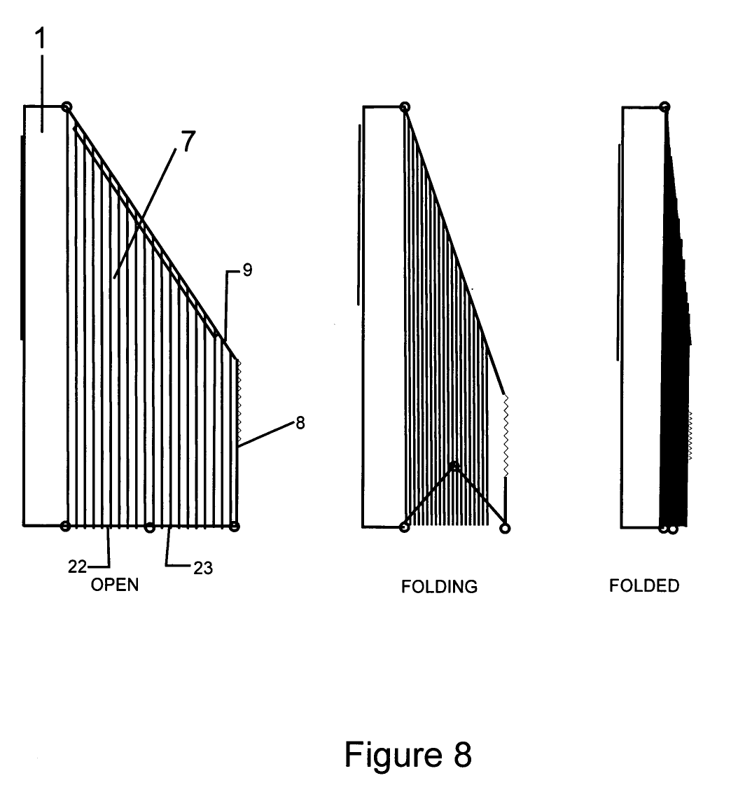

In this embodiment, folding proceeds as follows: After opening its removal doorway 5, projector 11, is electrically disconnected, disengaged from its support and removed from the system by pulling forward. After removal of the projector, any additional removable components may be removed through the opening where the projector previously resided. At this point, a slight lifting on the bottom sections 22 and 23 at the point where they are hingeably connected will start the folding operation. Simultaneously, a downward pressure on rear sloping section 9 allows it to slide downward while remaining connected to rear section 8 by means of sliding members in a groove. This process is shown in FIG. 8 where the system is partly folded. As the folding process proceeds, an optical component, said mirror 13, swings forward while remaining attached to rear sloping section 9.

After being fully folded, the system appears as shown in FIG. 10. A latching mechanism is provided to lock the system together in the fully folded position where it may be handled easily and carried in any position.

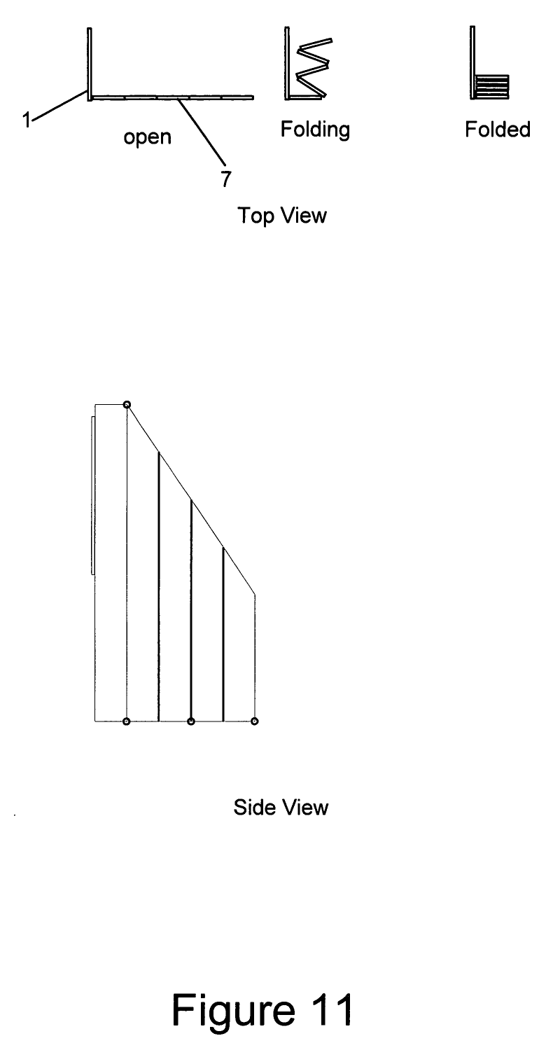

Details of the folding sides in a third embodiment is shown in FIG. 11 as a variation of the first embodiment. In this version, the sides of the cabinet 6 and 7 are rigid and hingeably attached to the main cabinet section 1 at a point far enough rearward that these sides fold inward into the base cabinet 1. A latching mechanism then binds the entire system together in a compact bundle. This same hinged rigid side arrangement may also be applied to either of the embodiments previously discussed.

The screen itself, although appearing herein to be a rigid structure, may actually be made of a flexible material and designed to fold or roll up for storage or transport, or used separately for another purpose.

After removing the projector from the cabinet, the projector becomes a free-standing unit and may be used as a front projection assembly with a separate screen or the screen removed from the foldable TV set. Thus, the use of a standard projector in this system adds a great deal to its versatility.

Although three embodiments of the system with variations have been shown in some detail here, other modifications based on these principles will undoubtedly occur to one skilled in the art. The particular details presented here are not intended to limit the invention to these embodiments, but to show some applications of the principle of folding to achieve a compact transportable unit. The invention is intended to encompass all embodiments that employ the same basic principles.

1. A projection television system comprising:
a foldable frame or cabinet,
one or more detachable plug-in speakers,
a detachable projector,
one or more projection mirrors,
to a viewing screen, and
a cavity behind said viewing screen.

2. The system of claim 1 wherein said foldable frame comprises rigid sections that form into a cabinet when unfolded.

3. The system of claim 1 wherein said speakers and projector are electrically connected by means of slot connectors and electrical wiring carried in said foldable frame or cabinet.

4. The system of claim 1 wherein said projection mirrors are detachable from the frame or cabinet.

5. The system of claim 1 wherein said viewing screen is detachable.

5. The system of claim 1 wherein said viewing screen is foldable.

6. The system of claim 1 wherein said viewing screen is flexible and may be rolled up.

7. The system of claim 1 wherein said projector is suitable for either front or rear projection television.

8. A method for transporting a rear projection television set comprising:
removal of a detachable projector,
removal of any other detachable components,
folding a foldable frame or cabinet into a compact unit, and
latching the entire system together securely for transport.
